(19) United States
(12) Patent Application Publication
(10) Pub. No.: US 2006/0187146 A1
(43) Pub. Date: Aug. 24, 2006

(54) Plasma display apparatus and driving method of the same

(75) Inventors: Ji Seung Yoo, Yongin-si (KR); Seong Hak Moon, Seoul (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/220,565

(22) Filed: Sep. 8, 2005

(30) Foreign Application Priority Data
Feb. 23, 2005 (KR) 2005-0014956

(51) Int. Cl. G09G 3/28

(52) U.S. Cl. 345/63

(57) ABSTRACT

A plasma display apparatus and the method of driving the same are disclosed. The plasma display apparatus includes a plasma display panel in which a plurality of scan electrodes and sustain electrodes are formed on a top substrate to make pairs and address electrodes are formed on a bottom substrate to intersect the scan electrodes and the sustain electrodes, electrode driving parts for driving the scan electrodes, the sustain electrodes, and the address electrodes, and a sustain pulse control part for controlling the driving parts such that the width of the sustain pulse applied to the scan electrodes or the sustain electrodes in the sustain period of the sub-field that displays the lowermost gray scales smaller than the width of the sustain pulses of the sub-fields that display the other gray scales. According to a method of driving the plasma display apparatus, each of a plurality of sub-fields having different number of times of light emission is divided into a reset period, an address period, and a sustain period. The width of the sustain pulse applied in the sustain period of the sub-field that displays the lowermost gray scale among the plurality of sub-fields is smaller than the width of the sustain pulses applied in the sustain periods of the sub-fields that display the other gray scales.

This nonprovisional application claims priority under 35 U.S.C. § 119(a) on patent application Ser. No. 10-2005-0014956 filed in Korea on Feb. 23, 2005, the entire contents of which are hereby incorporated by reference.

### BACKGROUND OF THE INVENTION

1. Field of the Invention

The present invention relates to a plasma display apparatus, and more particularly to a plasma display apparatus capable of improving image quality, a method of driving the same.

2. Description of the Background Art

In general, a plasma display panel (PDP) emits light from a fluorescent body by ultraviolet (UV) rays of 147 nm generated when an inactive mixed gas such as He+Xe or Ne+Xe is discharged to display images including characters and graphics.

FIG. 1 is a perspective view illustrating the structure of a conventional three-electrode AC surface discharge type PDP having discharge cells arranged in a matrix. Referring to FIG. 1, a three-electrode AC surface discharge type PDP 100 includes a scan electrode 11a and a sustain electrode 12a formed on a top substrate 10 and an address electrode 22 formed on a bottom substrate 20. The scan electrode 11a and the sustain electrode 12a are formed of a transparent electrode, for example, indium-tin-oxide (ITO), respectively. Metal bus electrodes 11b and 12b for reducing resistance are formed in the scan electrode 11a and the sustain electrode 12a, respectively. A top dielectric layer 13a and a protective layer 14 are laminated on the top substrate 10 on which the scan electrode 11a and the sustain electrode 12a are formed. Wall charges generated during plasma discharge are accumulated on the top dielectric layer 13a. The protective layer 14 prevents the top dielectric layer 13a from being damaged by sputtering generated during plasma discharge and improves efficiency of emitting secondary electrons. MgO is commonly used as the protective layer 14.

On the other hand, a bottom dielectric layer 13b and a partition wall 21 are formed on a bottom substrate 20 on which the address electrode 22 is formed and the surfaces of the bottom dielectric layer 13b and the partition wall 21 are coated with a fluorescent body layer 23. The address electrode 22 is formed to intersect the scan electrode 11a and the sustain electrode 12a. The partition wall 21 is formed to run parallel with the address electrode 22 to prevent ultraviolet (UV) rays and visible rays generated by discharge from leaking to an adjacent discharge cell. The fluorescent body layer 23 is excited by the UV rays generated during plasma discharge to generate any one visible ray among red (R), green (G), and blue (B) visible rays. An inactive mixed gas such as He+Xe or Ne+Xe for discharge is implanted into a discharge space of discharge cells partitioned by the partition wall 21 provided between the top substrate 10 and the bottom substrate 20. A method of driving a conventional PDP having such a structure will be described with reference to FIG. 2.

FIG. 2 illustrates driving waveforms for describing the method of driving the conventional PDP. Referring to FIG. 2, the period in which the conventional PDP is driven is divided into a reset period for initializing the entire screen, an address period for selecting a cell, and a sustain period for sustaining the discharge of the selected cell.

First, the reset period is divided into a set-up period SU and a set-down period SD. A rising ramp waveform Ramp-up is simultaneously applied to all of scan electrodes Y in the set-up period SU. Discharge occurs in the cells of the entire screen due to the rising ramp waveform. Positive wall charges are accumulated on address electrodes X and sustain electrodes Z and negative wall charges are accumulated on the scan electrodes Y due to the set-up discharge. In the set-down period SD, a falling ramp waveform Ramp-down that starts to fall to a positive voltage lower than the peak voltage of the rising ramp waveform to thus fall to a ground voltage GND or a negative specific voltage level after the rising ramp waveform is supplied generates weak erase discharge in cells to erase a part of the excessively formed wall charges. The wall charges to the amount that can stably generate address discharge uniformly reside in the cells due to the set-down discharge.

In the address period, a negative scan pulse Scan is sequentially applied to the scan electrodes Y and, at the same time, a positive data pulse data is applied to the address electrodes X in synchronization with the scan pulse. When difference in voltage between the scan pulse and the data pulse is added to the wall voltage generated in the reset period, address discharge is generated in the cell to which the data pulse is applied.

Wall charges to the amount that can generate discharge when a sustain voltage is applied are formed in the cells selected by the address discharge. A positive DC voltage Zdc is supplied to the sustain electrodes Z to reduce the difference in voltage between the sustain electrodes Z and the scan electrodes Y in the set-down period and the address period such that mis-discharge between the sustain electrodes Z and the scan electrodes Y is not generated.

In the sustain period, sustain pulses sus are alternately applied to the scan electrodes Y and the sustain electrodes Z. In the cells selected by the address discharge, the wall voltage in the cells is added to the sustain pulse such that the sustain discharge, that is, display discharge is generated between the scan electrodes Y and the sustain electrodes Z whenever each sustain pulse is applied. Also, after the sustain discharge is completed, a ramp waveform Ramp-ers having small pulse width and voltage level is supplied to the sustain electrodes Z to erase the wall charges that reside in the cells of the entire screen.

A method of displaying image gray scales of the conventional PDP that is driven as described above will be described as follows. FIG. 3 illustrates a method of displaying the image gray scales of the conventional PDP. As illustrated in FIG. 3, the image gray scales of the PDP are driven by dividing one frame into various sub-fields having different number of times of light emission. The respective sub-fields are divided into a reset period for uniformly generating discharge, an address period for selecting discharge cells, and a sustain period for realizing gray scales in accordance with the number of times of discharge. For example, when an image is to be displayed by 256 gray scales, a frame period (16.67 ms) corresponding to 1/60 second is divided into eight sub-fields and each of the eight sub-fields is divided into the address period and the sustain period. Here, meanwhile the reset period and the address period of each sub field are the same, the sustain period in each sub-field increases in the ratio of 2n (n=0. 1. 2. 3. 4. 5. 6, and 7).

As described above, the image gray scales of the conventional PDP are displayed by controlling the number of times of discharge generated in the sustain period of each sub-field. To be more specific, the gray scales are displayed by the brightness weight given to each sub-field. When the brightness weight of the first sub-field SF1 is set as 2⁰, as illustrated in the above-described method of driving the conventional PDP, the data pulse is supplied to the address electrodes X in the address period of the first sub-field SF1 and the scan pulse is sequentially supplied to the scan electrodes Y in synchronization with the data pulse. When the difference in voltage between the data pulse and the scan pulse is added to the wall voltage in the cells, the address discharge is generated in the cells to which the data pulse is applied. At this time, in the sustain period of the first sub-field SF1, the sustain pulse corresponding to the brightness weight 2⁰ is supplied such that, in the cells selected in the address period, the sustain pulse is added to the inner wall voltage to generate discharge and to thus display gray scales. However, according to such a method of displaying gray scales of the conventional PDP, it is not possible to display gray scales whose brightness weight is no more than 2⁰, that is, 1. That is, in the conventional PDP, each sub-field is set as brightness weight of a natural number and the brightness weight obtained by combining the sub-fields set as brightness weights of natural numbers is also displayed by a natural number.

Therefore, according to the method of displaying the gray scales of the conventional PDP, it is not possible to display minute gray scales no more than a natural number. As a result, there is limitation on improving picture quality.

### SUMMARY OF THE INVENTION

Accordingly, an object of the present invention is to solve at least the problems and disadvantages of the background art.

It is an object of the present invention to provide a plasma display apparatus capable of displaying minute gray scales no more than a natural number to improve picture quality, an apparatus for driving a plasma display panel, a plasma display panel, and a method of driving the same.

In order to achieve the above object, a plasma display apparatus according to a first embodiment of the present invention comprises a plasma display panel in which a plurality of scan electrodes and sustain electrodes are formed on a top substrate to make pairs and address electrodes are formed on a bottom substrate to intersect the scan electrodes and the sustain electrodes, electrode driving parts for driving the scan electrodes, the sustain electrodes, and the address electrodes, and a sustain pulse control part for controlling the driving parts such that the width of the sustain pulse applied to the scan electrodes or the sustain electrodes in the sustain period of the sub-field that displays the lowermost gray scales smaller than the width of the sustain pulses of the sub-fields that display the other gray scales.

The sustain pulse control part controls the width of the sustain pulse applied in the sustain period of the sub-field that displays the lowermost gray scale to be no more than 3 l μs.

The sustain pulse control part controls the driving parts to apply the sustain pulse applied in order to display the lowermost gray scale to either the scan electrodes or the sustain electrodes

A plasma display apparatus according to a second embodiment of the present invention comprises a plasma display panel in which a plurality of scan electrodes and sustain electrodes are formed on a top substrate to make pairs and address electrodes are formed on a bottom substrate to intersect the scan electrodes and the sustain electrodes, electrode driving parts for driving the scan electrodes, the sustain electrodes, and the address electrodes, and a sustain pulse control part for controlling the driving parts such that the voltage of the sustain pulse applied to the scan electrodes or the sustain electrodes in the sustain period of the sub-field that displays the lowermost gray scales smaller than the voltage of the sustain pulses of the sub-fields that display the other gray scales.

The sustain pulse control part according to the second embodiment makes the voltage of the sustain pulse applied in order to display the lowermost gray scale lower than a sustain voltage.

At this time, the sustain pulse applied in order to display the lowermost gray scale is applied to either the scan electrodes or the sustain electrodes.

A plasma display apparatus according to a third embodiment of the present invention comprises a plasma display panel in which a plurality of scan electrodes and sustain electrodes are formed on a top substrate to make pairs and address electrodes are formed on a bottom substrate to intersect the scan electrodes and the sustain electrodes, electrode driving parts for driving the scan electrodes, the sustain electrodes, and the address electrodes, and a sustain pulse control part for controlling the driving parts such that the slope of the sustain pulse applied to the scan electrodes or the sustain electrodes in the sustain period of the sub-field that displays the lowermost gray scales smaller than the slope of the sustain pulses of the sub-fields that display the other gray scales.

The sustain pulse control part according to the third embodiment makes the slope of the sustain pulse applied in order to display the lowermost gray scale no more than 50V/μs.

At this time, the sustain pulse applied in order to display the lowermost gray scale is applied to either the scan electrodes or the sustain electrodes.

In a method of driving a plasma display apparatus according to the first embodiment of the present invention, each of a plurality of sub-fields having different number of times of light emission is divided into a reset period, an address period, and a sustain period. The width of the sustain pulse applied in the sustain period of the sub-field that displays the lowermost gray scale among the plurality of sub-fields is smaller than the width of the sustain pulses applied in the sustain periods of the sub-fields that display the other gray scales.

At this time, the width of the sustain pulse applied in the sustain period of the sub-field that displays the lowermost gray scale is no more than 3 μs.

At this time, the sustain pulse applied in the sustain period of the sub-field that displays the lowermost gray scale is applied to either the scan electrodes or the sustain electrodes.

In a method of driving a plasma display apparatus according to the second embodiment of the present invention, each of a plurality of sub-fields having different number of times of light emission is divided into a reset period, an address period, and a sustain period. The voltage of the sustain pulse applied in the sustain period of the sub-field that displays the lowermost gray scale among the plurality of sub-fields is smaller than the voltage of the sustain pulses applied in the sustain periods of the sub-fields that display the other gray scales.

At this time, the voltage of the sustain pulse applied in the sustain period of the sub-field that displays the lowermost gray scale is lower than a sustain voltage Vs.

At this time, the sustain pulse applied in the sustain period of the sub-field that displays the lowermost gray scale is applied to either the scan electrodes or the sustain electrodes.

In a method of driving a plasma display apparatus according to the third embodiment of the present invention, each of a plurality of sub-fields having different number of times of light emission divided into a reset period, an address period, and a sustain period. The slope of the sustain pulse applied in the sustain period of the sub-field that displays the lowermost gray scale among the plurality of sub-fields is smaller than the slope of the sustain pulses applied in the sustain periods of the sub-fields that display the other gray scales.

At this time, the slope of the sustain pulse applied in the sustain period of the sub-field that displays the lowermost gray scale is no more than 50V/μs.

At this time, the sustain pulse applied in the sustain period of the sub-field that displays the lowermost gray scale is applied to either the scan electrodes or the sustain electrodes.

### BRIEF DESCRIPTION OF THE DRAWINGS

The present invention will be described in detail with reference to the following drawings in which like numerals refer to like elements.

FIG. 1 is a perspective view illustrating the structure of a conventional three-electrode AC surface discharge type plasma display panel (PDP) having discharge cells arranged in a matrix.

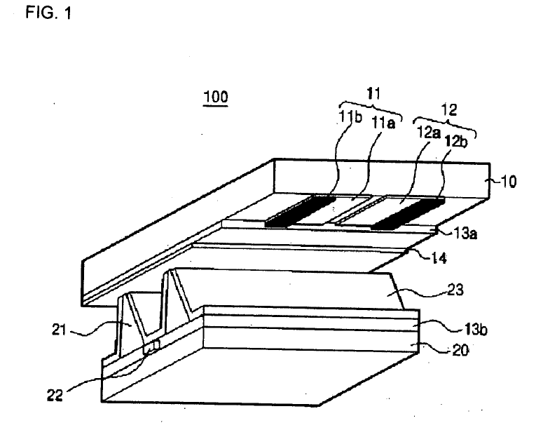

FIG. 2 illustrates driving waveforms for describing a method of driving the conventional PDP.

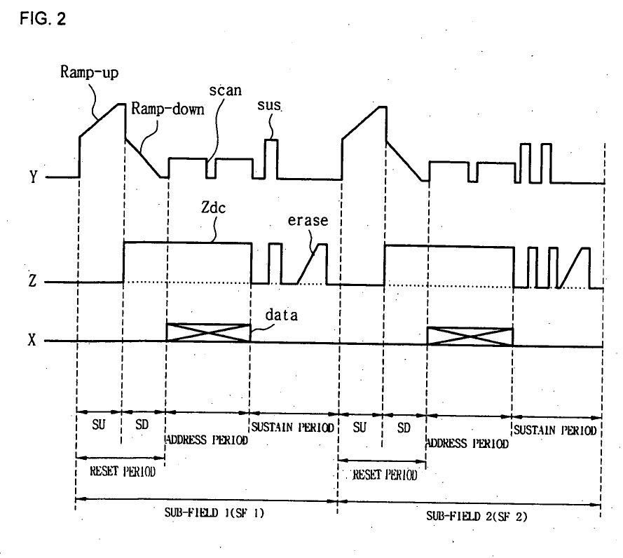

FIG. 3 illustrates a method of displaying image gray scales of the conventional PDP.

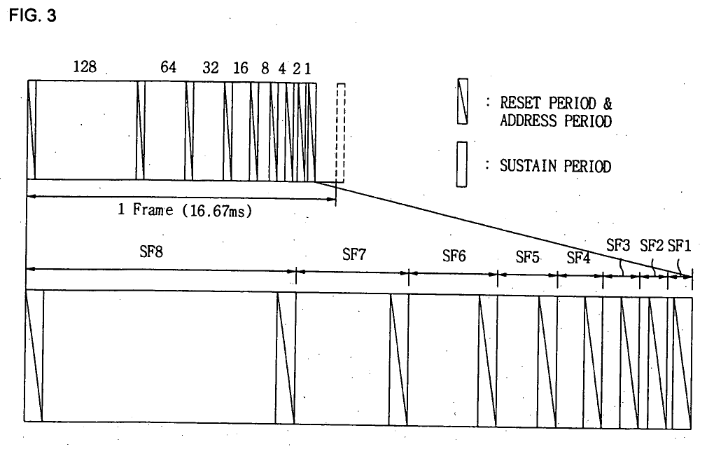

FIG. 4 illustrates a plasma display apparatus according to a first embodiment of the present invention.

FIG. 5 illustrates a method of driving the plasma display apparatus according to the first embodiment of the present invention.

FIG. 6 illustrates a plasma display apparatus according to a second embodiment of the present invention.

FIG. 7 illustrates a method of driving the plasma display apparatus according to the second embodiment of the present invention.

FIG. 8 illustrates a plasma display apparatus according to a third embodiment of the present invention.

FIG. 9 illustrates a method of driving the plasma display apparatus according to the third embodiment of the present invention.

### DETAILED DESCRIPTION OF PREFERRED EMBODIMENTS

Preferred embodiments of the present invention will be described in a more detailed manner with reference to the drawings.

### First Embodiment

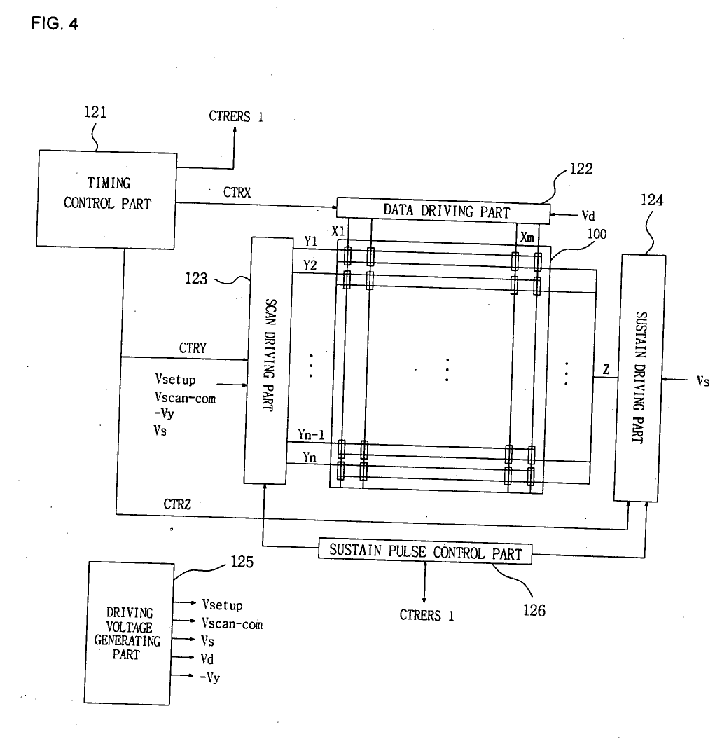

FIG. 4 illustrates a plasma display apparatus according to a first embodiment of the present invention. Referring to FIG. 4, the plasma display apparatus according to the first embodiment of the present invention includes a plasma display panel 100, a data driving part 122 for supplying data to address electrodes X1 to Xm formed on a bottom substrate (not shown) of the plasma display panel 100, a scan driving part 123 for driving scan electrodes Y1 to Yn, a sustain driving part 124 for driving sustain electrodes Z that is a common electrodes, a sustain pulse control part 126 for controlling the width of a sustain pulse in the sub-field that displays the lowermost gray scale, a timing control part 121 for controlling the data driving part 122, the scan driving part 123, the sustain driving part 124, and the sustain pulse control part 126 when the plasma display panel is driven, and a driving voltage generating part 125 for supplying necessary driving voltage to the respective driving parts 122, 123, and 124.

In the plasma display panel 100, a top substrate (not shown) and a bottom substrate (not shown) are attached to each other by uniform distance. On the top substrate, a plurality of electrodes, for example, the scan electrodes Y1 to Yn and the sustain electrodes Z are formed to make pairs. On the bottom substrate, the address electrodes X1 to Xm are formed so as to intersect the scan electrodes Y1 to Yn and the sustain electrodes Z.

Data that is inverse gamma corrected and error diffused by an inverse gamma correcting circuit and an error diffusing circuit that are not shown and then, is mapped by a sub-field mapping circuit in each sub-field is supplied to the data driving part 122. The data driving part 122 samples and latches data in response to a timing control signal CTRX from the timing control part 121 and supplies the data to the address electrodes X1 to Xm.

The scan driving part 123 supplies a rising ramp waveform Ramp-up and a falling ramp waveform Ramp-down to the scan electrodes Y1 to Yn under the control of the timing control part 121 in a reset period. Also, the scan driving part 123 sequentially supplies the scan pulse scan of a scan voltage −Vy to the scan electrodes Y1 to Yn under the control of the timing controller 121 in an address period and supplies a sustain pulse sus whose width is controlled by the sustain pulse control part 126 in accordance with brightness weight, that is, a gray scale value to the scan electrodes Y1 to Yn in a sustain period. The sustain pulse sus whose width is controlled is preferably supplied to the scan electrodes Y1 to Yn in the sustain period of the sub-field that displays the lowermost gray scale. Here, the lowermost gray scale refers to the gray scale value in the sub-field having the smallest brightness weight when the gray scales are displayed by giving brightness weights to the respective sub-fields when a plasma display panel is divided into a plurality of sub-fields to be driven. To be specific, the lowermost gray scale refers to the gray scale obtained by supplying the sustain pulse having the brightness weight of no more than 2⁰ in the sustain period of a predetermined sub-field.

The sustain driving part 124 supplies the bias voltage of a sustain voltage Vs to the sustain electrodes Z under the control of the timing control part 121 in a period where the falling ramp waveform Ramp-down is generated and in an address period and alternately operates together with the scan driving part 123 in the sustain period to supply the sustain pulse sus to the sustain electrodes Z. Also, the sustain driving part 124 supplies the sustain pulse sus whose width is controlled by the sustain pulse control part 126 in accordance with the brightness weight, that is, the gray scale value to the scan electrodes Y1 to Yn under the control of the timing control part 121 in the sustain period like the scan driving part 123. The sustain pulse whose width is controlled is preferably supplied to the sustain electrodes Z in the sub-field that displays the lowermost gray scale among the plurality of sub-fields under the control of the timing control part.

A sustain pulse control part 126 controls the width of the sustain pulse supplied in the sustain period in accordance with the gray scale value of the data mapped in each sub-field in response to the control signal of a timing control part 121. The sustain pulse having width W1 different from the width W2 of the sustain pulses applied in the sustain periods of the sub-fields that display the other gray scales is preferably supplied to a scan driving part 123 and a sustain driving part 124 in the sustain period of the sub-field that displays the lowermost gray scale among the plurality of sub-fields. That is, the width W1 of the sustain pulse that displays the lowermost gray scale is larger than the minimum width that can perform sustain discharge and is smaller than the width W2 of the sustain pulses that display the other gray scales. At this time, the sustain pulse that displays the lowermost gray scale is applied to either the scan electrodes Y1 to Yn or the sustain electrodes Z and the width of the sustain pulse that displalys the lowermost gray scale is controlled to be no more than 3 μs.

3 μs that is the uppermost value of the width of the sustain pulse lets the sustain pulse having common width have difference in gray scale in comparison with the amount of the light supplied to the scan electrodes Y1 to Yn or the sustain electrodes Z. The sustain pulse control part 126 may be built in the scan driving part 133 or the sustain driving part 124.

The timing control part 121 receives vertical/horizontal synchronizing signals and a clock signal, generates timing control signals CTRX, CTRY, CTRZ, and CTRERS1 for controlling the operation timings and the synchronizations of the respective driving parts 122, 123, and 124 and the sustain pulse control part 126 in the reset period, the address period, and the sustain period, and supplies the timing control signals CTRX, CTRY, CTRZ, and CTRERS1 to the corresponding driving parts 122, 123, and 124 and the sustain pulse control part 126 to control the respective driving and control parts 122, 123, 124, and 126.

On the other hand, a sampling clock for sampling data, a latch control signal, and a switch control signal for controlling the on/off times of an energy collecting circuit and a driving switch element are included in the data control signal CTRX. A switch control signal for controlling the on/off times of the energy collecting circuit and the driving switch element in the scan driving part 123 is included in the scan control signal CTRY. A switch control signal for controlling the on/off times of the energy collecting circuit and the driving switch element in the sustain driving part 124 is included in the sustain control signal CTRZ.

The driving voltage generating part 125 generates a set-up voltage Vsetup, a scan common voltage Vscan-com, a scan voltage −Vy, a sustain voltage Vs, and a data voltage Vd. Such driving voltages may change due to the composition of a discharge gas or the structure of a discharge cell.

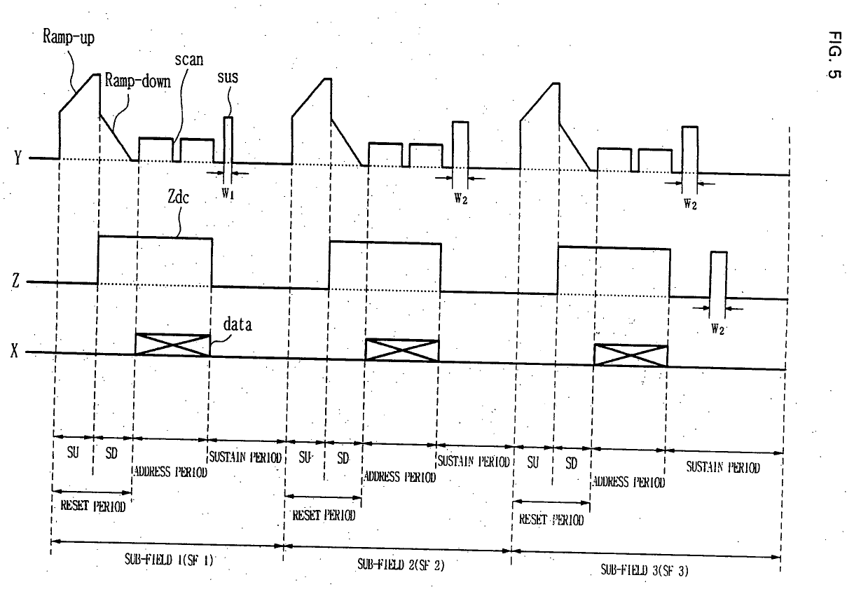

FIG. 5 illustrates a method of driving a plasma display apparatus according to a first embodiment of the present invention. Referring to FIG. 5, according to the method of driving the plasma display panel according to the first embodiment of the present invention, a frame period is time-divided into a plurality of sub-fields SF1, SF2, SF3, SF4, . . . each including the reset period, the address period, and the sustain period. Each sub-field is set to have a predetermined brightness weight. To be specific, the width of the sustain pulse supplied in the sub-field SF1 having the smallest brightness weight is controlled to be different from the width of the sustain pulses supplied in the sub-fields SF2, SF3, SF4, . . . having different bright weights, which will be described in more detail.

(First Sub-Field)

First, in the reset period of the first sub-field SF1, a high positive reset pulse (not shown) or a set-up/set-down pulses in the form of a ramp signal having predetermined slopes are supplied to the scan electrodes Y such that reset discharge is generated in the cells of the entire screen. Since wall charges are uniformly accumulated in the cells of the entire screen due to the reset discharge, a uniform discharge characteristic is obtained.

In the address period, a data pulse data is supplied to the address electrodes X and a negative scan pulse scan is sequentially supplied to the scan electrodes Y in synchronization with the data pulse data. When difference in voltage between the scan pulse and the data pulse is added to the wall voltage generated in the reset period, address discharge is generated in the cell to which the data pulse is applied.

In the sustain period, sustain pulses sus may be alternately supplied to the scan electrodes Y or the sustain electrodes Z. However, as illustrated in FIG. 5, the sustain pulse is preferably supplied to either the scan electrodes Y or the sustain electrodes Z and the width W1 of the sustain pulse is preferably smaller than the width W2 of the sustain pulses applied in the sustain periods of the other sub-fields SF2, SF3, SF4, . . . . The width W1 of the sustain pulse is no more than 3 μs. As described above, the uppermost value of the width W1 of the sustain pulse lets the sustain pulses having common width W2 have difference in gray scale in comparison with the amount of light supplied to a panel.

(Second Sub-Field)

The reset period and the address period of the second sub-field SF2 are the same as the reset period and the address period of the first sub-field. In the sustain period, the sustain pulses sus may be alternately supplied to the scan electrodes Y or the sustain electrodes Z like in the first sub-field. However, as illustrated in FIG. 5, the sustain pulse is preferably supplied to either scan electrodes Y or the sustain electrodes Z to generate sustain discharge. At this time, the width W2 of the sustain pulse is the same as the width W2 of the conventional common sustain pulses.

(Third Sub-Field)

The reset period and the address period of the third sub-field SF3 are the same as the reset period and the address period of the first sub-field. In the sustain period, the sustain pulses sus are alternately supplied to the scan electrodes Y or the sustain electrodes Z. At this time, the width W2 of the sustain pulses is the same as the width W2 of the conventional common sustain pulses. According to the plasma display panel in the first embodiment of the present invention driven as described above, in the sub-field SF2 where the sustain pulse is applied to either the scan electrodes Y or the sustain electrodes Z, a smaller gray scale value than the gray scale value in accordance with the light in the sub-field SF3 where the sustain pulses are alternately applied to the scan electrodes and the sustain electrodes is displayed. Also, when the sustain pulse is applied to either the scan electrodes and the sustain electrodes, in the sub-field SF1 where the sustain pulse having the smaller width W1 than the width W2 of the sustain pulses of the other sub-fields SF2, SF3, SF4, . . . is applied, it is possible to display minute gray scale values.

Also, according to the method of driving the conventional PDP in which the sustain pulses are alternately applied to the scan electrodes and the sustain electrodes to display gray scales, it is possible to display minute gray scale values by reducing the width of the sustain pulses.

### Second Embodiment

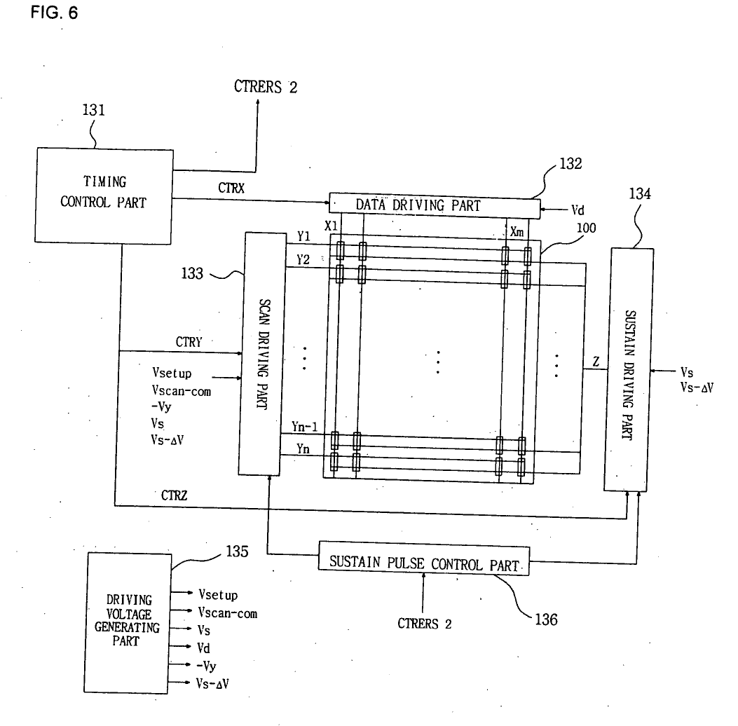

FIG. 6 illustrates a plasma display apparatus according to a second embodiment of the present invention. Referring to FIG. 6, the plasma display apparatus according to the second embodiment of the present invention includes a plasma display panel 100, a data driving part 132 for supplying data to address electrodes X1 to Xm formed on a bottom substrate (not shown) of the plasma display panel 100, a scan driving part 133 for driving scan electrodes Y1 to Yn, a sustain driving part 134 for driving sustain electrodes Z that is a common electrodes, a sustain pulse control part 136 for controlling the voltage of a sustain pulse in the sub-field that displays the lowermost gray scale, a timing control part 131 for controlling the data driving part 132, the scan driving part 133, the sustain driving part 134, and the sustain pulse control part 136 when the plasma display panel is driven, and a driving voltage generating part 135 for supplying necessary driving voltage to the respective driving parts 132, 133, and 134 like in the first embodiment.

In the plasma display panel 100, a top substrate (not shown) and a bottom substrate (not shown) are attached to each other by uniform distance like in the first embodiment. On the top substrate, a plurality of electrodes, for example, the scan electrodes Y1 to Yn and the sustain electrodes Z are formed to make pairs. On the bottom substrate, the address electrodes X1 to Xm are formed so as to intersect the scan electrodes Y1 to Yn and the sustain electrodes Z.

Data that is inverse gamma corrected and error diffused by an inverse gamma correcting circuit and an error diffusing circuit that are not shown and then, is mapped by a sub-field mapping circuit in each sub-field is supplied to the data driving part 132. The data driving part 132 samples and latches data in response to a timing control signal CTRX from the timing control part 131 and supplies the data to the address electrodes X1 to Xm.

The scan driving part 133 supplies a rising ramp waveform Ramp-up and a falling ramp waveform Ramp-down to the scan electrodes Y1 to Yn under the control of the timing control part 131 in a reset period. Also, the scan driving part 133 sequentially supplies the scan pulse scan of a scan voltage −Vy to the scan electrodes Y1 to Yn under the control of the timing controller 131 in an address period and supplies a sustain pulse sus whose voltage is controlled by the sustain pulse control part 136 in accordance with brightness weight, that is, a gray scale value to the scan electrodes Y1 to Yn in a sustain period. The sustain pulse sus whose voltage is controlled is preferably supplied to the scan electrodes Y1 to Yn in the sustain period of the sub-field that displays the lowermost gray scale. Here, the lowermost gray scale refers to the gray scale value in the sub-field having the smallest brightness weight when the gray scales are displayed by giving brightness weights to the respective sub-fields when a plasma display panel is divided into a plurality of sub-fields to be driven. To be specific, the lowermost gray scale refers to the gray scale obtained by supplying the sustain pulse having the brightness weight of no more than 2⁰ in the sustain period of a predetermined sub-field.

The sustain driving part 134 supplies the bias voltage of a sustain voltage Vs to the sustain electrodes Z under the control of the timing control part 131 in a period where the falling ramp waveform Ramp-down is generated and in an address period and alternately operates together with the scan driving part 133 in the sustain period to supply the sustain pulse sus to the sustain electrodes Z. Also, the sustain driving part 134 supplies the sustain pulse sus whose voltage is controlled by the sustain pulse control part 136 in accordance with the brightness weight, that is, the gray scale value to the scan electrodes Y1 to Yn under the control of the timing control part 131 in the sustain period like the scan driving part 133. The sustain pulse whose voltage is controlled is preferably supplied to the sustain electrodes Z in the sub-field that displays the lowermost gray scale among the plurality of sub-fields under the control of the timing control part.

A sustain pulse control part 136 controls the voltage Vs of the sustain pulse supplied in the sustain period in accordance with the gray scale value of the data mapped in each sub-field in response to the control signal of a timing control part 131. The sustain pulse having voltage Vs-ΔV different from the voltage Vs of the sustain pulses applied in the sustain periods of the sub-fields that display the other gray scales is preferably supplied to a scan driving part 133 and a sustain driving part 134 in the sustain period of the sub-field that displays the lowermost gray scale among the plurality of sub-fields. At this time, the voltage of the sustain pulse that displays the lowermost gray scale is larger than the minimum voltage that starts discharge and is smaller than the voltage Vs of the sustain pulses that display the other gray scales. At this time, the sustain pulse that displays the lowermost gray scale is applied to either the scan electrodes Y1 to Yn or the sustain electrodes Z. The sustain pulse control part 136 may be built in the scan driving part 133 or the sustain driving part 134.

The timing control part 131 receives vertical/horizontal synchronizing signals and a clock signal, generates timing control signals CTRX, CTRY, CTRZ, and CTRERS2 for controlling the operation timings and the synchronizations of the respective driving parts 132, 133, and 134 and the sustain pulse control part 136 in the reset period, the address period, and the sustain period, and supplies the timing control signals CTRX, CTRY, CTRZ, and CTRERS2 to the corresponding driving parts 132, 133, and 134 and the sustain pulse control part 136 to control the respective driving and control parts 132, 133, 134, and 136.

On the other hand, a sampling clock for sampling data, a latch control signal, and a switch control signal for controlling the on/off times of an energy collecting circuit and a driving switch element are included in the data control signal CTRX. A switch control signal for controlling the on/off times of the energy collecting circuit and the driving switch element in the scan driving part 133 is included in the scan control signal CTRY. A switch control signal for controlling the on/off times of the energy collecting circuit and the driving switch element in the sustain driving part 124 is included in the sustain control signal CTRZ. Also, a control signal of a switch element for selecting the voltage of the sustain pulse is included in the sustain pulse voltage control signal CTRRES2.

The driving voltage generating part 135 generates a set-up voltage Vsetup, a scan common voltage Vscan-com, a scan voltage −Vy, a sustain voltage Vs, a data voltage Vd, and the voltage Vs-ΔV no more than the sustain voltage Vs. Such driving voltages may change due to the composition of a discharge gas or the structure of a discharge cell.

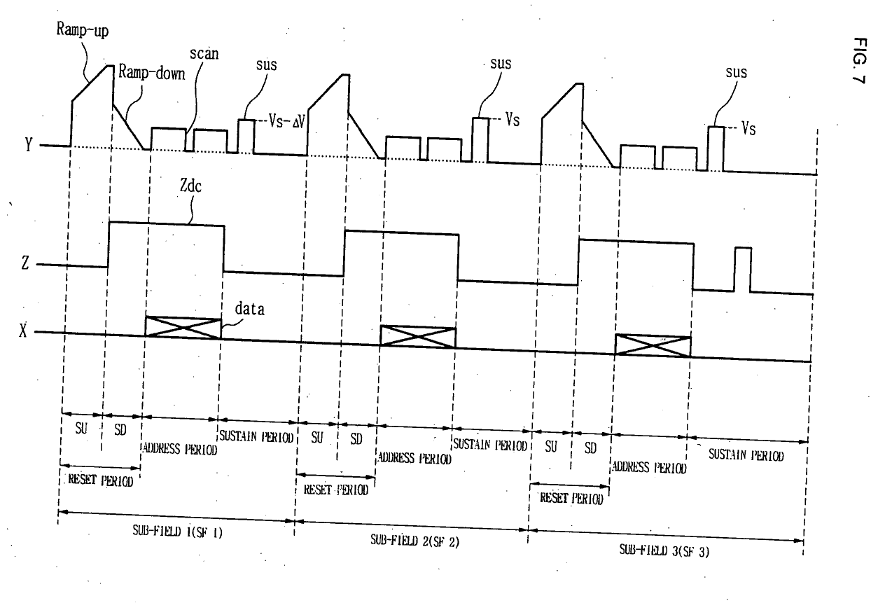

FIG. 7 illustrates a method of driving a plasma display apparatus according to a second embodiment of the present invention. Referring to FIG. 7, according .to the method of driving the plasma display panel according to the second embodiment of the present invention, a frame period is time-divided into a plurality of sub-fields SF1, SF2, SF3, SF4, . . . each including the reset period, the address period, and the sustain period. Each sub-field is set to have a predetermined brightness weight. To be specific, the voltage of the sustain pulse supplied in the sub-field SF1 having the smallest brightness weight is controlled to be different from the voltage of the sustain pulses supplied in the sub-fields SF2, SF3, SF4, . . . having different bright weights, which will be described in more detail.

(First Sub-Field)

First, in the reset period of the first sub-field SF1, a high positive reset pulse (not shown) or a set-up/set-down pulses in the form of a ramp signal having predetermined slopes are supplied to the scan electrodes Y such that reset discharge is generated in the cells of the entire screen. Since wall charges are uniformly accumulated in the cells of the entire screen due to the reset discharge, a uniform discharge characteristic is obtained.

In the address period, a data pulse data is supplied to the address electrodes X and a negative scan pulse scan is sequentially supplied to the scan electrodes Y in synchronization with the data pulse data. When difference in voltage between the scan pulse and the data pulse is added to the wall voltage generated in the reset period, address discharge is generated in the cell to which the data pulse is applied.

In the sustain period, sustain pulses sus may be alternately supplied to the scan electrodes Y or the sustain electrodes Z. However, as illustrated in FIG. 7, the sustain pulse is preferably supplied to either the scan electrodes Y or the sustain electrodes Z and the voltage Vs-ΔV of the sustain pulse is preferably smaller than the voltage Vs of the sustain pulses applied in the sustain periods of the other sub-fields SF2, SF3, SF4, . . . . In such a case, the voltage Vs-ΔV of the sustain pulse must be higher than the voltage Vf for starting discharge.

(Second Sub-Field)

The reset period and the address period of the second sub-field SF2 are the same as the reset period and the address period of the first sub-field. In the sustain period, the sustain pulses sus may be alternately supplied to the scan electrodes Y or the sustain electrodes Z like in the first sub-field. However, as illustrated in FIG. 5, the sustain pulse is preferably supplied to either scan electrodes Y or the sustain electrodes Z to generate sustain discharge. At this time, the voltage Vs of the sustain pulse is the same as the voltage Vs of the conventional common sustain pulses.

(Third Sub-Field)

The reset period and the address period of the third sub-field SF3 are the same as the reset period and the address period of the first sub-field. In the sustain period, the sustain pulses sus are alternately supplied to the scan electrodes Y or the sustain electrodes Z. At this time, the voltage Vs of the sustain pulses is the same as the voltage Vs of the conventional common sustain pulses. According to the plasma display panel in the second embodiment of the present invention driven as described above, in the sub-field SF2 where the sustain pulse is applied to either the scan electrodes Y or the sustain electrodes Z, a smaller gray scale value than the gray scale value in accordance with the light in the sub-field SF3 where the sustain pulses are alternately applied to the scan electrodes and the sustain electrodes is displayed.

Also, when the sustain pulse is applied to either the scan electrodes and the sustain electrodes, in the sub-field SF1 where the sustain pulse having the smaller voltage than the voltage Vs of the sustain pulses of the other sub-fields SF2, SF3, SF4, . . . is applied, it is possible to display minute gray scale values.

Also, according to the method of driving the conventional PDP in which the sustain pulses are alternately applied to the scan electrodes and the sustain electrodes to display gray scales, it is possible to display minute gray scale values by reducing the voltage of the sustain pulses like in the method of driving the plasma display panel according to the first embodiment.

### Third Embodiment

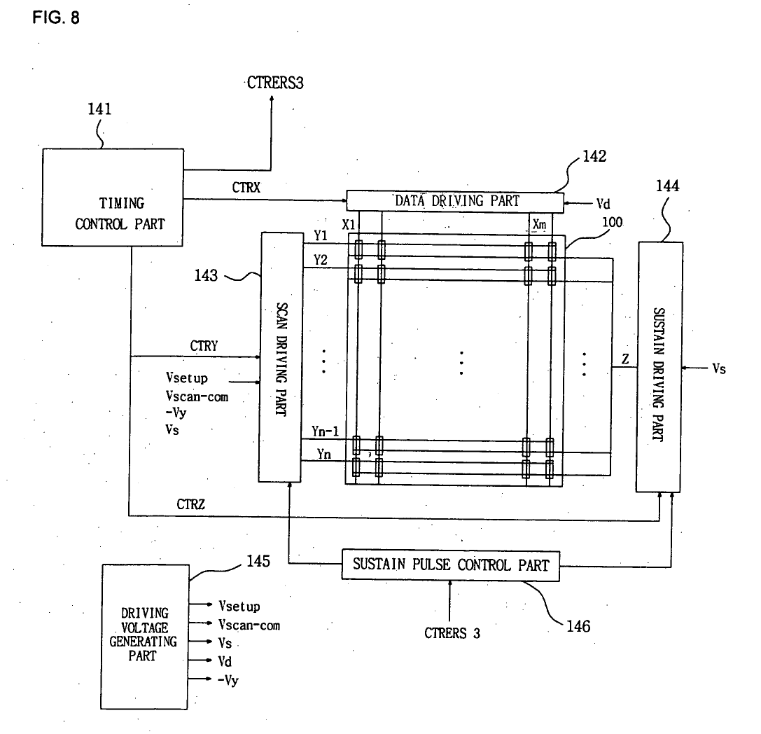

FIG. 8 illustrates a plasma display apparatus according to a third embodiment of the present invention. Referring to FIG. 8, the plasma display apparatus according to the third embodiment of the present invention includes a plasma display panel 100, a data driving part 142 for supplying data to address electrodes X1 to Xm formed on a bottom substrate (not shown) of the plasma display panel 100, a scan driving part 143 for driving scan electrodes Y1 to Yn, a sustain driving part 144 for driving sustain electrodes Z that is a common electrodes, a sustain pulse control part 146 for controlling the slope of a sustain pulse in the sub-field that displays the lowermost gray scale, a timing control part 141 for controlling the data driving part 142, the scan driving part 143, the sustain driving part 144, and the sustain pulse control part 146 when the plasma display panel is driven, and a driving voltage generating part 145 for supplying necessary driving voltage to the respective driving parts 142, 143, and 144.

In the plasma display panel 100, a top substrate (not shown) and a bottom substrate (not shown) are attached to each other by uniform distance. On the top substrate, a plurality of electrodes, for example, the scan electrodes Y1 to Yn and the sustain electrodes Z are formed to make pairs. On the bottom substrate, the address electrodes X1 to Xm are formed so as to intersect the scan electrodes Y1 to Yn and the sustain electrodes Z like in the first embodiment.

Data that is inverse gamma corrected and error diffused by an inverse gamma correcting circuit and an error diffusing circuit that are not shown and then, is mapped by a sub-field mapping circuit in each sub-field is supplied to the data driving part 142. The data driving part 142 samples and latches data in response to a timing control signal CTRX from the timing control part 141 and supplies the data to the address electrodes X1 to Xm.

The scan driving part 143 supplies a rising ramp waveform Ramp-up and a falling ramp waveform Ramp-down to the scan electrodes Y1 to Yn under the control of the timing control part 141 in a reset period. Also, the scan driving part 143 sequentially supplies the scan pulse scan of a scan voltage −Vy to the scan electrodes Y1 to Yn under the control of the timing controller 141 in an address period and supplies a sustain pulse sus whose slope is controlled by the sustain pulse control part 146 in accordance with brightness weight, that is, a gray scale value to the scan electrodes Y1 to Yn in a sustain period. The sustain pulse sus whose slope is controlled is preferably supplied to the scan electrodes Y1 to Yn in the sustain period of the sub-field that displays the lowermost gray scale. Here, the lowermost gray scale refers to the gray scale value in the sub-field having the smallest brightness weight when the gray scales are displayed by giving brightness weights to the respective sub-fields when a plasma display panel is divided into a plurality of sub-fields to be driven. To be specific, the lowermost gray scale refers to the gray scale obtained by supplying the sustain pulse having the brightness weight of no more than 2⁰ in the sustain period of a predetermined sub-field.

The sustain driving part 144 supplies the bias voltage of a sustain voltage Vs to the sustain electrodes Z under the control of the timing control part 141 in a period where the falling ramp waveform Ramp-down is generated and in an address period and alternately operates together with the scan driving part 143 in the sustain period to supply the sustain pulse sus to the sustain electrodes Z. Also, the sustain driving part 144 supplies the sustain pulse sus whose slope is controlled by the sustain pulse control part 146 in accordance with the brightness weight, that is, the gray scale value to the scan electrodes Y1 to Yn under the control of the timing control part 141 in the sustain period like the scan driving part 143. The sustain pulse whose slope is controlled is preferably supplied to the sustain electrodes Z in the sub-field that displays the lowermost gray scale among the plurality of sub-fields under the control of the timing control part 141.

A sustain pulse control part 146 controls the slope of the sustain pulse supplied in the sustain period in accordance with the gray scale value of the data mapped in each sub-field in response to the control signal of a timing control part 141. The sustain pulse having slope different from the slope of the sustain pulses applied in the sustain periods of the sub-fields that display the other gray scales is preferably supplied to a scan driving part 143 and a sustain driving part 144 in the sustain period of the sub-field that displays the lowermost gray scale among the plurality of sub-fields. At this time, the slope of the sustain pulse that displays the lowermost gray scale is smaller than the slope of the sustain pulses that display the other gray scales. Also, the sustain pulse that displays the lowermost gray scale is applied either the scan electrodes Y1 to Yn or the sustain electrodes Z. The sustain pulse control part 146 may be built in the scan driving part 143 or the sustain driving part 144.

The timing control part 141 receives vertical/horizontal synchronizing signals and a clock signal, generates timing control signals CTRX, CTRY, CTRZ, and CTRERS3 for controlling the operation timings and the synchronizations of the respective driving parts 142, 143, and 144 and the sustain pulse control part 146 in the reset period, the address period, and the sustain period, and supplies the timing control signals CTRX, CTRY, CTRZ, and CTRERS3 to the corresponding driving parts 142, 143, and 144 and the sustain pulse control part 146 to control the respective driving and control parts 142, 143, 144, and 146.

On the other hand, a sampling clock for sampling data, a latch control signal, and a switch control signal for controlling the on/off times of an energy collecting circuit and a driving switch element are included in the data control signal CTRX. A switch control signal for controlling the on/off times of the energy collecting circuit and the driving switch element in the scan driving part 123 is included in the scan control signal CTRY. A switch control signal for controlling the on/off times of the energy collecting circuit and the driving switch element in the sustain driving part 144 is included in the sustain control signal CTRZ. Also, a control signal of a switch element for selecting the slope of the sustain pulse is included in the slope control signal CTRRES3 of the sustain pulse.

The driving voltage generating part 145 generates a set-up voltage Vsetup, a scan common voltage Vscan-com, a scan voltage −Vy, a sustain voltage Vs, and a data voltage Vd. Such driving voltages may change due to the composition of a discharge gas or the structure of a discharge cell.

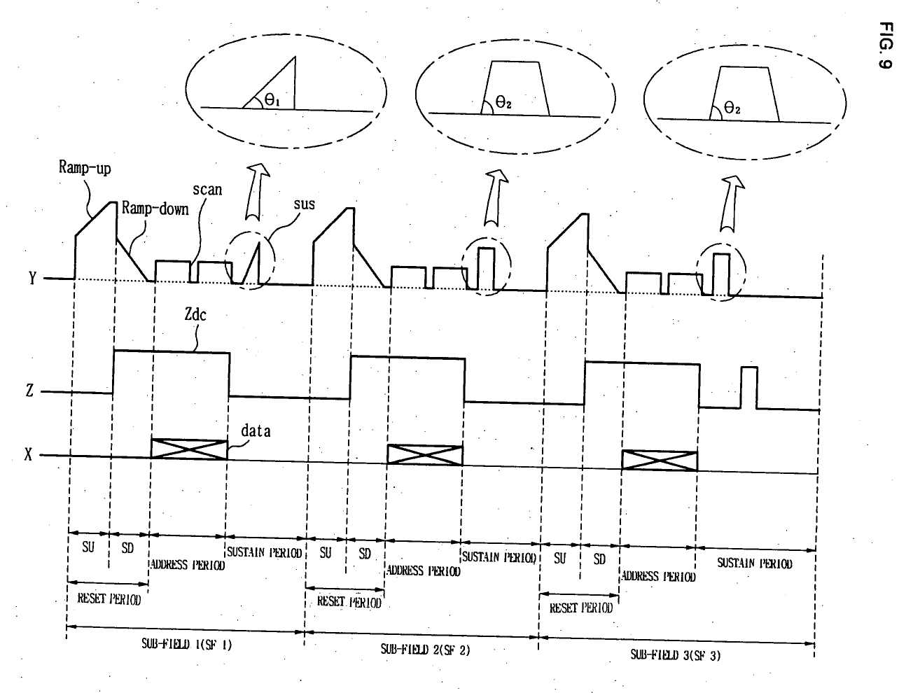

FIG. 9 illustrates a method of driving a plasma display apparatus according to a third embodiment of the present invention. Referring to FIG. 9, according to the method of driving the plasma display panel according to the third embodiment of the present invention, a frame period is time-divided into a plurality of sub-fields SF1, SF2, SF3, SF4, . . . each including the reset period, the address period, and the sustain period. Each sub-field is set to have a predetermined brightness weight. To be specific, the slope of the sustain pulse supplied in the sub-field SF1 having the smallest brightness weight is controlled to be different from the slope of the sustain pulses supplied in the sub-fields SF2, SF3, SF4, . . . having different bright weights, which will be described in more detail.

(First Sub-Field)

First, in the reset period of the first sub-field SF1, a high positive reset pulse (not shown) or a set-up/set-down pulses in the form of a ramp signal having predetermined slopes are supplied to the scan electrodes Y such that reset discharge is generated in the cells of the entire screen. Since wall charges are uniformly accumulated in the cells of the entire screen due to the reset discharge, a uniform discharge characteristic is obtained.

In the address period, a data pulse data is supplied to the address electrodes X and a scan pulse scan is sequentially supplied to the scan electrodes Y in synchronization with the data pulse data. When difference in voltage between the scan pulse and the data pulse is added to the wall voltage in the cells, address discharge is generated in the cell to which the data pulse is applied.

In the sustain period, sustain pulses sus may be alternately supplied to the scan electrodes Y or the sustain electrodes Z. However, as illustrated in FIG. 9, the sustain pulse is preferably supplied to either the scan electrodes Y or the sustain electrodes Z and the slope θ1 of the sustain pulse is preferably smaller than the slope θ2 of the sustain pulses applied in the sustain periods of the other sub-fields SF2, SF3, SF4 . . . . That is, the uppermost value 50V/μs of the slope θ1 of the sustain pulse lets the sustain pulse having a common slope have difference in gray scale in comparison with the amount of light supplied to the scan electrodes Y1 to Yn or the sustain electrodes Z.

(Second Sub-Field)

The reset period and the address period of the second sub-field SF2 are the same as the reset period and the address period of the first sub-field. In the sustain period, the sustain pulses sus may be alternately supplied to the scan electrodes Y or the sustain electrodes Z like in the first sub-field. However, as illustrated in FIG. 9, the sustain pulse is preferably supplied to either scan electrodes Y or the sustain electrodes Z to generate sustain discharge. At this time, the slope θ2 of the sustain pulse is the same as the slope of the conventional common sustain pulses.

(Third Sub-Field)

The reset period and the address period of the third sub-field SF3 are the same as the reset period and the address period of the first sub-field. In the sustain period, the sustain pulses sus are alternately supplied to the scan electrodes Y or the sustain electrodes Z. At this time, the slope of the sustain pulses is the same as the slope of the conventional common sustain pulses. According to the plasma display panel in the third embodiment of the present invention driven as described above, in the sub-field SF2 where the sustain pulse is applied to either the scan electrodes Y or the sustain electrodes Z, a smaller gray scale value than the gray scale value in accordance with the light in the sub-field SF3 where the sustain pulses are alternately applied to the scan electrodes and the sustain electrodes is displayed.

Also, when the sustain pulse is applied to either the scan electrodes and the sustain electrodes, in the sub-field SF1 where the sustain pulse having the smaller slope than the slope of the sustain pulses of the other sub-fields SF2, SF3, SF4, . . . is applied, it is possible to display minute gray scale values.

Also, according to the method of driving the conventional PDP in which the sustain pulses are alternately applied to the scan electrodes and the sustain electrodes to display gray scales, it is possible to display minute gray scale values by reducing the slope of the sustain pulses like in the method of driving the plasma display panel according to the second embodiment.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

As described above, according to the present invention, brightness weights no more than a natural number are given to the sub-fields to display minute gray scales such that it is possible to improve the picture quality of the plasma display panel.

What is claimed is:

1. A plasma display apparatus comprising:
a plasma display panel in which a plurality of scan electrodes and sustain electrodes are formed on a top substrate to make pairs;
electrode driving parts for driving the scan electrodes and the sustain electrodes respectively; and
a sustain pulse control part for controlling the driving parts such that the width of the sustain pulse applied to the scan electrodes or the sustain electrodes, in the sustain period of the sub-field that displays the lowermost gray scale, is smaller than the width of the sustain pulse of the sub-field that displays the other gray scale.

2. The plasma display apparatus as claimed in claim 1, wherein the sustain pulse control part controls the width of the sustain pulse applied, in the sustain period of the sub-field that displays the lowermost gray scale, to be 3 μs and below.

3. The plasma display apparatus as claimed in claim 1 or 2, wherein the sustain pulse control part controls the driving parts to apply the sustain pulse applied in order to display the lowermost gray scale to either the scan electrodes or the sustain electrodes

4. A plasma display apparatus comprising:
a plasma display panel in which a plurality of scan electrodes and sustain electrodes are formed on a top substrate to make pairs;
electrode driving parts for driving the scan electrodes and the sustain electrodes; and
a sustain pulse control part for controlling the driving parts such that the voltage of the sustain pulse applied to the scan electrodes or the sustain electrodes in the sustain period of the sub-field that displays the lowermost gray scales smaller than the voltage of the sustain pulses of the sub-fields that display the other gray scales.

5. The plasma display apparatus as claimed in claim 4, wherein the sustain pulse control part makes the voltage of the sustain pulse applied in order to display the lowermost gray scale lower than a sustain voltage.

6. The plasma display apparatus as claimed in claim 4 or 5, wherein the sustain pulse applied in order to display the lowermost gray scale is applied to either the scan electrodes or the sustain electrodes.

7. A plasma display apparatus comprising:
a plasma display panel in which a plurality of scan electrodes and sustain electrodes are formed on a top substrate to make pairs;
electrode driving parts for driving the scan electrodes and the sustain electrodes; and
a sustain pulse control part for controlling the driving parts such that the slope of the sustain pulse applied to the scan electrodes or the sustain electrodes, in the sustain period of the sub-field that displays the lowermost gray scales, is smaller than the slope of the sustain pulse of the sub-field that displays the other gray scales.

8. The plasma display apparatus as claimed in claim 7, wherein the sustain pulse control part controls the slope of the sustain pulse applied in order to display the lowermost gray scale to be 50V/μs and below.

9. The plasma display apparatus as claimed in claim 7 or 8, wherein the sustain pulse applied in order to display the lowermost gray scale is applied to either the scan electrodes or the sustain electrodes.

10. An apparatus for driving a plasma display panel in which a plurality of scan electrodes and sustain electrodes are formed on a top substrate to make pairs, the apparatus comprising:
electrode driving parts for driving the scan electrodes and the sustain electrodes; and
a sustain pulse control part for controlling the driving parts such that the width of the sustain pulse applied to the scan electrodes or the sustain electrodes, in the sustain period of the sub-field that displays the lowermost gray scales, is smaller than the width of the sustain pulses of the sub-fields that display the other gray scales.

11. An apparatus for driving a plasma display panel in which a plurality of scan electrodes and sustain electrodes are formed on a top substrate to make pairs, the apparatus comprising:
electrode driving parts for driving the scan electrodes and the sustain electrodes; and
a sustain pulse control part for controlling the driving parts such that the voltage of the sustain pulse applied to the scan electrodes or the sustain electrodes, in the sustain period of the sub-field that displays the lowermost gray scales, is smaller than the voltage of the sustain pulse of the sub-field that displays the other gray scales.

12. An apparatus for driving a plasma display panel in which a plurality of scan electrodes and sustain electrodes are formed on a top substrate to make pairs, the apparatus comprising:
electrode driving parts for driving the scan electrodes and the sustain electrodes; and
a sustain pulse control part for controlling the driving parts such that the slope of the sustain pulse applied to the scan electrodes or the sustain electrodes, in the sustain period of the sub-field that displays the lowermost gray scales, is smaller than the slope of the sustain pulse of the sub-field that displays the other gray scales.

13. A plasma display panel in which a plurality of scan electrodes and sustain electrodes are formed on a top substrate to make pairs, wherein, in the sustain period of the sub-field that displays the lowermost gray scale, the width of the sustain pulse applied to the scan electrodes or the sustain electrodes is smaller than the width of the sustain pulse of the sub-field that displays the other gray scales.

14. A plasma display panel in which a plurality of scan electrodes and sustain electrodes are formed on a top substrate to make pairs, wherein, in the sustain period of the sub-field that displays the lowermost gray scale, the voltage of the sustain pulse applied to the scan electrodes or the sustain electrodes is smaller than the voltage of the sustain pulse of the sub-field that displays the other gray scales.

15. A plasma display panel in which a plurality of scan electrodes and sustain electrodes are formed on a top substrate to make pairs, wherein, in the sustain period of the sub-field that displays the lowermost gray scale, the slope of the sustain pulse applied to the scan electrodes or the sustain electrodes is smaller than the slope of the sustain pulse of the sub-field that displays the other gray scales.

16. A method of driving a plasma display apparatus that displays images with each of a plurality of sub-fields having different number of times of light emission divided into a reset period, an address period, and a sustain period, wherein the width of the sustain pulse, applied in the sustain period of the sub-field that displays the lowermost gray scale among the plurality of sub-fields, is smaller than the width of the sustain pulse applied in the sustain periods of the sub-field that displays the other gray scales.

17. A method of driving a plasma display apparatus that displays images with each of a plurality of sub-fields having different number of times of light emission divided into a reset period, an address period, and a sustain period, wherein the voltage of the sustain pulse, applied in the sustain period of the sub-field that displays the lowermost gray scale among the plurality of sub-fields, is smaller than the voltage of the sustain pulses applied in the sustain period of the sub-field that displays the other gray scales.

18. A method of driving a plasma display apparatus that displays images with each of a plurality of sub-fields having different number of times of light emission divided into a reset period, an address period, and a sustain period, wherein the slope of the sustain pulse applied in the sustain period of the sub-field that displays the lowermost gray scale among the plurality of sub-fields is smaller than the slope of the sustain pulses applied in the sustain periods of the sub-fields that display the other gray scales.
